(19) United States
(12) Patent Application Publication
(10) Pub. No.: US 2012/0223867 A1
(43) Pub. Date: Sep. 6, 2012

(54) Antenna Device and Portable Radio Communication Device Comprising Such Antenna Device

(76) Inventors: Lee Morton, Uppsala (SE); Peter Lindberg, Uppsala (SE)

(21) Appl. No.: 13/371,745

(22) Filed: Feb. 13, 2012

(30) Foreign Application Priority Data
Mar. 1, 2011 (EP) 11156438.1

(51) Int. Cl. H01Q 11/12

(52) U.S. Cl. 343/742

(57) ABSTRACT

Exemplary embodiments are disclosed herein of antenna devices for radio communication devices. In an exemplary embodiment, an antenna device for a radio communication device is adapted for receiving radio signals in at least a first frequency band and a separate second frequency band. The antenna device includes a half-loop radiating. The first frequency band includes the first harmonic for the half-loop radiating element. The half-loop radiating element includes an inductive loading at a high current section for the third harmonic for the half-loop radiating element, such that the second frequency band includes the third harmonic for the half-loop radiating element.

### CROSS REFERENCE TO RELATED APPLICATION

This patent application claims priority of European application No. 11156438.1 filed Mar. 1, 2011. The disclosure of the application identified in this paragraph is incorporated herein by reference in its entirety.

### FIELD

The present disclosure relates generally to antenna devices and more particularly to an antenna device for a radio communication device, such as a mobile phone, comprising a half-loop radiating element.

### BACKGROUND

This section provides background information related to the present disclosure which is not necessarily prior art.

Internal antennas have been used for some time in portable radio communication devices. There are a number of advantages connected with using internal antennas, of which can be mentioned that they are small and light, making them suitable for applications wherein size and weight are of importance, such as in mobile phones.

However, the application of internal antennas in a mobile phone puts some constraints on the configuration of the antenna device. In particular, in a portable radio communication device the space for an internal antenna device is limited. These constraints may make it difficult to find a configuration of the antenna that provides for a wide operating band.

Further, a portable radio communication device is today many times required to be provided with multiple frequency band coverage for a plurality of operational frequency bands, such as GSM850, GSM900, GSM1800, GSM1900, and WCDMA. A portable radio communication device has limited space, and it is thus desirable to, if possible, add multiple functionality to an antenna device.

In order to provide an antenna device covering a broad frequency band, it is advantageous to arrange the radiating element off-ground. In a mobile phone having a large display, for example, it is often difficult to find available space for an off-ground antenna.

### SUMMARY

This section provides a general summary of the disclosure, and is not a comprehensive disclosure of its full scope or all of its features.

Exemplary embodiments are disclosed herein of antenna devices for radio communication devices. In an exemplary embodiment, an antenna device for a radio communication device is adapted for receiving radio signals in at least a first frequency band and a separate second frequency band. The antenna device includes a half-loop radiating. The first frequency band includes the first harmonic for the half-loop radiating element. The half-loop radiating element includes an inductive loading at a high current section for the third harmonic for the half-loop radiating element, such that the second frequency band includes the third harmonic for the half-loop radiating element.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a schematic illustration showing current and voltage maxima for a λ/2 mode for a half-loop antenna device.

FIG. 2 is a schematic illustration showing current and voltage maxima for a λ mode for a half-loop antenna device.

FIG. 3 is a schematic illustration showing current and voltage maxima for a 3λ/2 mode for a half-loop antenna device.

FIG. 4 is a schematic illustration showing current and voltage maxima for a 2λ mode for a half-loop antenna device.

FIG. 5 is a schematic illustration of a half-loop antenna device according to a first exemplary embodiment of the present disclosure.

FIG. 6 is a schematic illustration of a half-loop antenna device according to a second exemplary embodiment of the present disclosure.

FIG. 7 is a schematic illustration of a half-loop antenna device according to a third exemplary embodiment of the present disclosure.

FIG. 8 is a schematic illustration of the frequency band coverage according to the antenna device of the third exemplary embodiment shown in FIG. 7.

FIG. 9 is a schematic illustration of the frequency band coverage according to the first exemplary embodiment shown in FIG. 5 or second exemplary embodiment shown in FIG. 6.

Corresponding reference numerals indicate corresponding parts throughout the several views of the drawings.

### DETAILED DESCRIPTION

Example embodiments will now be described more fully with reference to the accompanying drawings.

Exemplary embodiments are disclosed herein of antenna devices for radio communication devices. In an exemplary embodiment, an antenna device for a radio communication device is adapted for receiving radio signals in at least a first frequency band and a separate second frequency band. The antenna device includes a half-loop radiating element. The first frequency band includes the first harmonic for the half-loop radiating element. The half-loop radiating element includes an inductive loading at a high current section for the third harmonic for the half-loop radiating element, such that the second frequency band includes the third harmonic for the half-loop radiating element, which allows use of an on-ground antenna having multiple operation frequency band coverage.

The first frequency band includes at least the first harmonic, and the second frequency band includes at least the second and third harmonic. Or, the first frequency band includes at least the first and second harmonic, and the second frequency band includes at least the third harmonic.

Exemplary embodiments disclosed herein may provide antenna devices for radio communication devices, which provide multiple operation frequency band coverage for an on-ground antenna. Aspects of this disclosure are based on the inventors' realization that a half-loop antenna may be configured for multiple operation frequency band coverage by certain configurations.

In exemplary embodiments, a half-loop radiating element may include an inductive loading at a high current section for the second harmonic for the half-loop radiating element, to allow for shifting of also the fourth harmonic. The half-loop radiating element may include a capacitive coupling means at a high differential voltage for the third harmonic for the half-loop radiating element, to improve the amount with which the third harmonic can be shifted in relation to the first harmonic of the half-loop radiating element. Further, the half-loop radiating element may have a predetermined width for the first harmonic, and the inductive loading is provided by the half-loop radiating element being narrower than the predetermined width for a higher harmonic. In addition, or alternatively, the inductive loading may include a meandering portion.

In order to shift the third harmonic down to the second harmonic and not shift down the second harmonic to the first harmonic, the half-loop radiating element, at voltage differential maxima for the second harmonic, are preferably not capacitive coupled in exemplary embodiments, such that the second frequency band also includes the second harmonic for the half-loop radiating element.

Also in exemplary embodiments, the half-loop radiating element may advantageously include capacitive coupling means at the voltage differential maxima for the fourth harmonic for the half-loop radiating element, and inductive loading at the current maxima for the fourth harmonic for the half-loop radiating element, such that the second frequency band is configured to include the second harmonic for the half-loop radiating element, the third harmonic for the half-loop radiating element as well as the fourth harmonic for the half-loop radiating element.

In exemplary embodiments, the half-loop radiating element may have a predetermined width for the first harmonic, and the capacitive means may be provided by a first part of the half-loop radiating element being widened towards a second part of the half-loop radiating element, compared to the predetermined width. Advantageously, the capacitive means may be further provided by a first part of the half-loop radiating element being interdigitated with a second part of the half-loop radiating element.

In exemplary embodiments, the half-loop radiating element may include capacitive coupling means at a high voltage differential for the second harmonic for the half-loop radiating element, such that the first frequency band also includes the second harmonic for the half-loop radiating element. To provide further operation frequency band coverage, the antenna device may further include a parasitic element configured to broaden the second frequency band.

A portable radio communication device that includes an antenna device disclosed herein is also provided in accordance with exemplary embodiments.

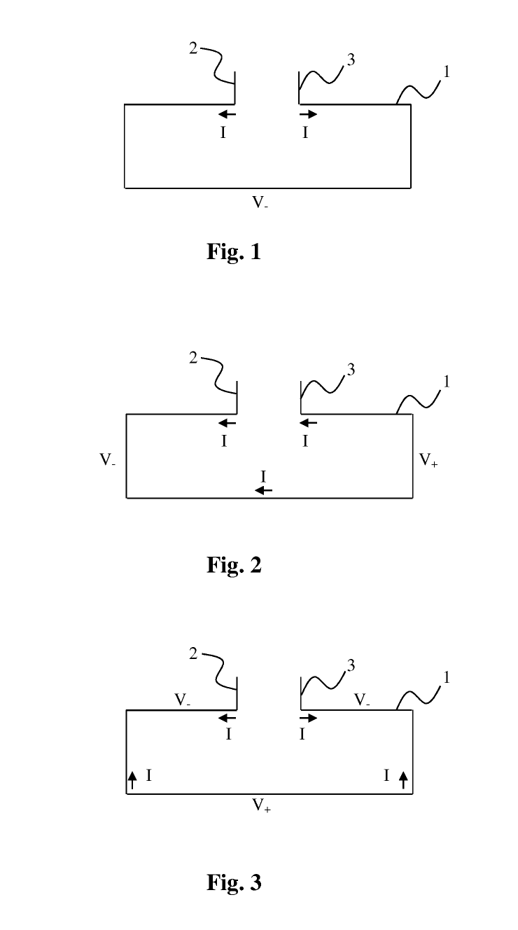

With reference to the figures, FIGS. 1-4 show a general configuration of an antenna device according to an exemplary embodiment of the present disclosure. As shown, the antenna device includes a radiating element 1 in the form of a half-loop radiating element 1. The half-loop radiating element 1 is fed 2 in one end and grounded 3 in the other end. A half-loop antenna includes a half-loop radiating element over a ground plane device, such as a PCB of a mobile phone or a radio frequency (RF) shield for a display for a mobile phone. A half-loop antenna has a half-loop radiating element 1 having a length of λ/2 for the first harmonic, which mirrored in over the ground plane device makes the antenna device function as a loop antenna.

FIG. 1 schematically illustrates the λ/2 mode, or the first harmonic, for a half-loop radiating element 1. In the first harmonic, a voltage differential maxima will appear in the middle of the loop, illustrated with a V−. In the first harmonic, the current maxima I will appear at the feeding and grounding, illustrated with arrows pointing in the direction of the current maxima.

FIG. 2 schematically illustrates the current and voltage maxima for the second harmonic of the half-loop radiating element 1, or the λ mode. In the second harmonic, a voltage differential maxima will appear at 120° and 240° of the half-loop, illustrated with a V− and V+ respectively. Current maxima I will for the second harmonic appear at the feeding, at the grounding, and in the middle of the loop, illustrated with arrows pointing in the direction of the current maxima.

FIG. 3 schematically illustrates the current and voltage maxima for the third harmonic of the half-loop radiating element 1 or the 3λ/2 mode. In the third harmonic, a voltage differential maxima will appear at 45°, 180° and 315° of the half-loop, illustrated with V− and V+ respectively. Current maxima I will for the third harmonic appear at the feeding, at the grounding and at 135° and 225° of the half-loop, illustrated with arrows pointing in the direction of the current maxima.

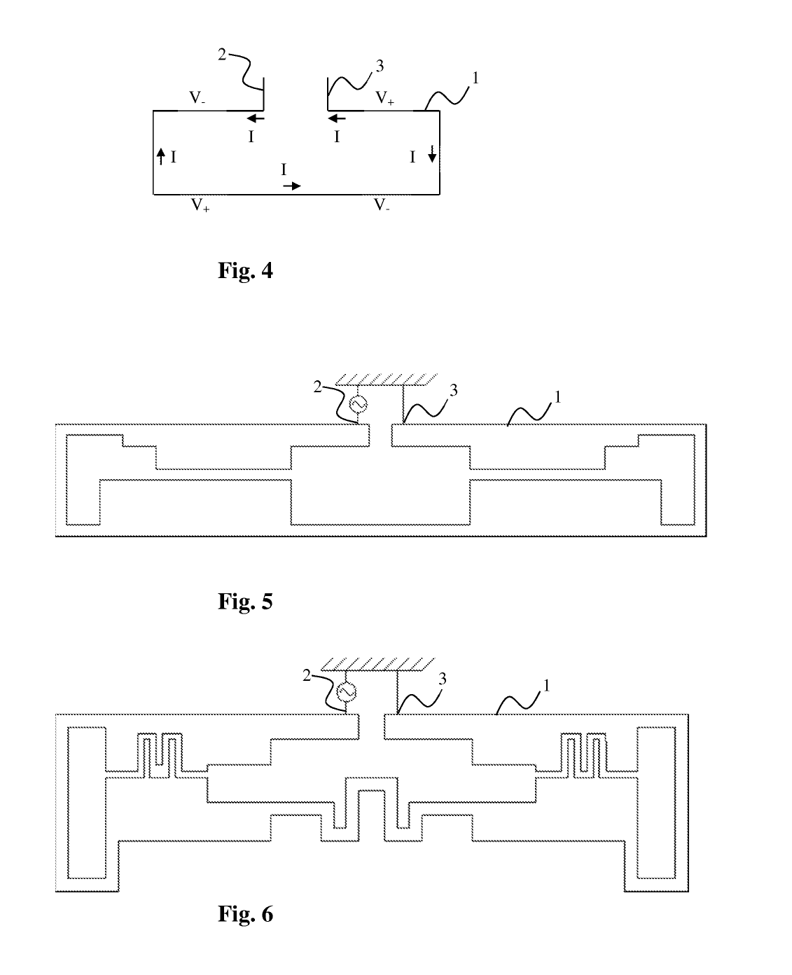

FIG. 4 schematically illustrates the current and voltage maxima for the fourth harmonic of the half-loop radiating element 1, or the 2λ mode. In the fourth harmonic a voltage differential maxima will appear at 45°, 135°, 225° and 315° of the half-loop, illustrated with V− and V+ respectively. Current maxima I will for the fourth harmonic appear at the feeding, at the grounding and at 120°, 180° and 240° of the half-loop, illustrated with arrows pointing in the direction of the current maxima.

For an antenna device having a half-loop radiating element 1 configured for e.g. 900 MHz, this will be the first harmonic. The half-loop radiating element 1 will then have higher harmonics in the following frequencies: second harmonic at 1800 MHz, third harmonic at 2700 MHz and fourth harmonic at 3600 MHz. For a mobile phone, or other portable radio communication device utilizing cellular communication, desired operating frequency bands are e.g. for GSM850, GSM900, GSM1800, GSM1900 and WCDMA#1.

A loop antenna having a first harmonic of 900 MHz will typically cover a first frequency band of GSM900 and a separate second frequency band of GSM1800. By providing the antenna device with inductive means at a high current section for the third harmonic, it is possible to shift the third harmonic down to the separate second frequency band and broaden it to cover also GSM1900, which frequency band coverage is illustrated in FIG. 9 and FIG. 5 schematically illustrating a first exemplary embodiment.

FIG. 5 illustrates a first exemplary embodiment of an antenna device for a radio communication device adapted for receiving radio signals in at least a first frequency band and a separate second frequency band. As shown, the antenna device includes a half-loop radiating element 1 wherein the first frequency band includes the first harmonic for the half-loop radiating element 1. The half-loop radiating element 1 includes inductive means at a high current section for the third harmonic for the half-loop radiating element 1, such that the second frequency band includes the third harmonic for the half-loop radiating element 1. The half-loop radiating element 1 is in one end 2 fed and in the other end 3 grounded to a ground plane device of the portable radio communication device in which the antenna device is arranged in during use. The ground plane device is typically a PCB or an RF-shield of a display of a mobile phone.

The half-loop radiating element 1, at voltage differential maxima for the second harmonic, are not capacitively coupled, such that the second frequency band includes the second harmonic, as well as the third harmonic, for the half-loop radiating element 1.

The half-loop radiating element 1 further includes capacitive coupling means at the voltage differential maxima for the fourth harmonic for the half-loop radiating element 1, and inductive loading at the current maxima for the fourth harmonic for the half-loop radiating element, such that the second frequency band is configured to include the second harmonic for the half-loop radiating element 1, the third harmonic for the half-loop radiating element 1 as well as the fourth harmonic for the half-loop radiating element 1.

For improved shifting of the third harmonic, the half-loop radiating element 1 includes an inductive loading at a high current section for the second harmonic for the half-loop radiating element 1.

The half-loop radiating element 1 has a predetermined width for the first harmonic, and the inductive loading is here provided by the half-loop radiating element 1 being narrower than the predetermined width for the third and fourth harmonic. An inductive loading of the loop structure could alternatively e.g. be provided by a lumped inductor, which may complicate the manufacturing process, and hence increase manufacturing costs.

In this first exemplary embodiment, the capacitive means is here provided by a first part of the half-loop radiating element 1 being widened towards a second part of the half-loop radiating element 1, compared to the predetermined width. With the distance between the two desired parts of the loop structure increased, capacitive coupling is achieved. A capacitive coupling between the two desired parts of the loop structure could alternatively e.g. be provided by a lumped capacitor, which may complicate the manufacturing process, and hence increase manufacturing costs.

With the third and fourth harmonic of the half-loop radiating element downshifted to the second harmonic, it is possible for the antenna device to provide quad operational band coverage in two frequency bands: GSM900 in the first frequency band and GSM1800, GSM1900 and WCDMA#1 in the second frequency band.

For adding additional operational frequency band coverage, such as GSM850 to the first frequency band, a parasitic element could be added to the antenna device.

FIG. 6 illustrates a second exemplary embodiment of an antenna device embodying one or more aspects of the present disclosure. This second embodiment is identical with the first embodiment described above apart from the following.

The half-loop radiating element 1 comprises a meandering portion to increase the inductive loading for the second and fourth harmonic.

A first part of the half-loop radiating element 1 is also interdigitated with a second part of the half-loop radiating element 1, to further increase the capacitive coupling between desired parts of the loop structure.

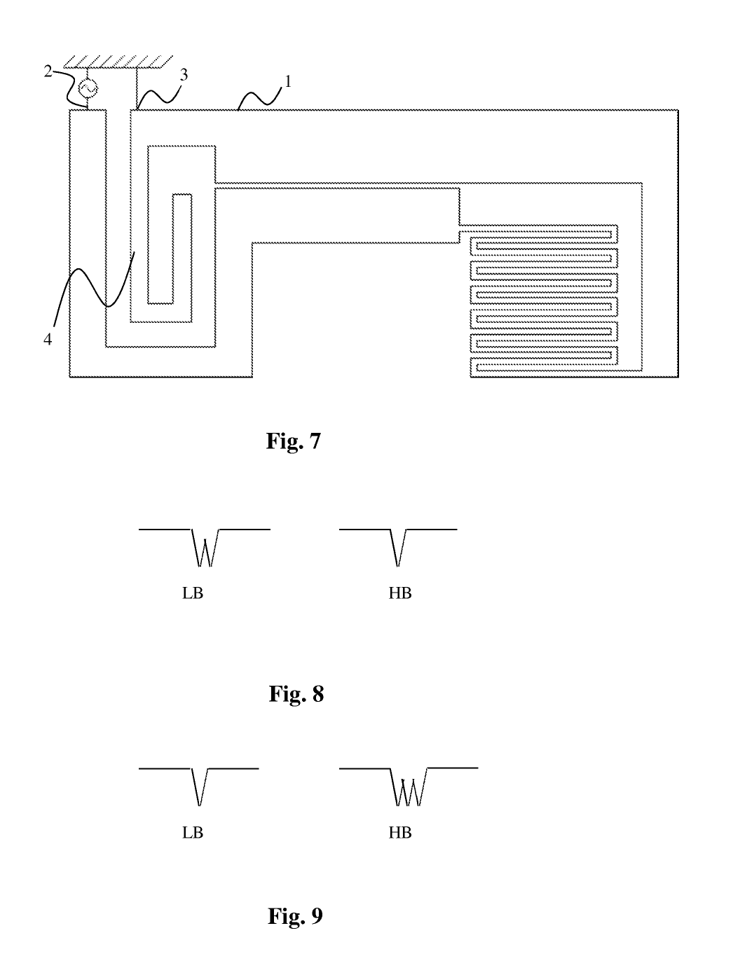

A third exemplary embodiment of the antenna device will now be described with reference to FIGS. 7 and 8. This third embodiment is identical with the first embodiment described above apart from the following.

The half-loop radiating element 1, at a high voltage differential for the second harmonic, is capacitive coupled, such that the second harmonic is shifted down to the first harmonic, and the first frequency band includes the first and second harmonic and the second frequency band includes the third harmonic, for the half-loop radiating element 1.

For improved shifting of the third harmonic, the half-loop radiating element 1 comprises an inductive loading at a high current section for the second harmonic for the half-loop radiating element 1.

With the third harmonic of the half-loop radiating element downshifted to the second frequency band, it is possible to for the antenna device to provide quad operational band coverage in two frequency bands: GSM850 and GSM900 in the first frequency band and GSM1800 and GSM1900 in the second frequency band.

For adding additional operational frequency band coverage, such as WCDMA#1 to the second frequency band, a parasitic element could be added to the antenna device.

Preferred exemplary embodiments of an antenna device according to the present disclosure have been described. However, the person skilled in the art realizes that these can be varied within the scope of the appended claims without departing from the inventive idea, aspects, or concepts disclosed herein. For example, the shape and size of an antenna device according to this disclosure can be varied within the scope defined by the appended claims. Thus, the exact antenna configurations can be varied so as to correspond to the shape of the radio communication device, desired performance, etc.

For purposes of explanation and not limitation, specific details are set forth, such as particular hardware, applications, techniques etc. in order to provide a more thorough understanding. But it will be apparent to one skilled in the art that the present disclosure may be utilized in other embodiments that depart from these specific details. In other instances, detailed descriptions of well-known methods, apparatuses, and circuits are omitted so as not to obscure the description of the disclosed antenna devices with unnecessary details.

In addition, the term radiating element is used herein. It is to be understood that this term is intended to cover electrically conductive elements arranged for receiving and/or transmitting radio signals.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

Specific dimensions, specific materials, and/or specific shapes disclosed herein are example in nature and do not limit the scope of the present disclosure. The disclosure herein of particular values and particular ranges of values for given parameters are not exclusive of other values and ranges of values (e.g., other frequency ranges) that may be useful in one or more of the examples disclosed herein. Moreover, it is envisioned that any two particular values for a specific parameter stated herein may define the endpoints of a range of values that may be suitable for the given parameter (the disclosure of a first value and a second value for a given parameter can be interpreted as disclosing that any value between the first and second values could also be employed for the given parameter). Similarly, it is envisioned that disclosure of two or more ranges of values for a parameter (whether such ranges are nested, overlapping, or distinct) subsume all possible combination of ranges for the value that might be claimed using endpoints of the disclosed ranges.

The terminology used herein is for the purpose of describing particular example embodiments only and is not intended to be limiting. As used herein, the singular forms “a”, “an” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on”, “engaged to”, “connected to” or “coupled to” another element or layer, it may be directly on, engaged, connected or coupled to the other element or layer, or intervening elements or layers may be present. In contrast, when an element is referred to as being “directly on,” “directly engaged to”, “directly connected to” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath”, “below”, “lower”, “above”, “upper” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

The foregoing description of the embodiments has been provided for purposes of illustration and description. It is not intended to be exhaustive or to limit the disclosure. Individual elements, intended or stated uses, or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. An antenna device for a radio communication device adapted for receiving radio signals in at least a first frequency band and a separate second frequency band, the antenna device comprising a half-loop radiating element, the first frequency band includes a first harmonic for the half-loop radiating element, the half-loop radiating element comprising an inductive loading at a high current section for a third harmonic for the half-loop radiating element, such that the second frequency band includes the third harmonic for the half-loop radiating element.

2. The antenna device of claim 1, wherein the half-loop radiating element comprises inductive loading at a high current section for a second harmonic for the half-loop radiating element.

3. The antenna device of claim 2, wherein the half-loop radiating element comprises capacitive coupling means at a high differential voltage for the third harmonic for the half-loop radiating element.

4. The antenna device of claim 3, wherein the half-loop radiating element has a predetermined width for the first harmonic, and the inductive loading is provided by the half-loop radiating element being narrower than the predetermined width for a higher harmonic.

5. The antenna device of claim 4, wherein the inductive loading comprises a meandering portion.

6. The antenna device of claim 3, wherein the inductive loading comprises a meandering portion.

7. The antenna device of claim 1, wherein the half-loop radiating element comprises capacitive coupling means at a high differential voltage for the third harmonic for the half-loop radiating element.

8. The antenna device of claim 7, wherein the half-loop radiating element has a predetermined width for the first harmonic, and the inductive loading is provided by the half-loop radiating element being narrower than the predetermined width for a higher harmonic.

9. The antenna device of claim 1, wherein the half-loop radiating element, at voltage differential maxima for the second harmonic, are not capacitively coupled, such that the second frequency band also includes the second harmonic for the half-loop radiating element.

10. The antenna device of claim 9, wherein the half-loop radiating element comprises capacitive coupling means at the voltage differential maxima for a fourth harmonic for the half-loop radiating element, and inductive loading at the current maxima for the fourth harmonic for the half-loop radiating element, such that the second frequency band is configured to include the second harmonic for the half-loop radiating element, the third harmonic for the half-loop radiating element as well as the fourth harmonic for the half-loop radiating element.

11. The antenna device of claim 10, wherein the half-loop radiating element has a predetermined width for the first harmonic, and the capacitive coupling means is provided by a first part of the half-loop radiating element being widened towards a second part of the half-loop radiating element, compared to the predetermined width.

12. The antenna device of claim 10, wherein the capacitive coupling means is provided by a first part of the half-loop radiating element being interdigitated with a second part of the half-loop radiating element.

13. The antenna device of claim 1, wherein the half-loop radiating element comprises capacitive coupling means at a high voltage differential for the second harmonic for the half-loop radiating element, such that the first frequency band also includes the second harmonic for the half-loop radiating element.

14. The antenna device of claim 13, further comprising a parasitic element configured to broaden the second frequency band.

15. The antenna device of claim 1, wherein:
the first frequency band covers at least GSM900; and
the second frequency band covers at least GSM1800 and GSM1900.

16. The antenna device of claim 1, wherein:
the first frequency band covers at least GSM850 and GSM900; and
the second frequency band covers at least GSM1800, GSM1900 and WCDMA.

17. The antenna device of claim 1, wherein:
the half-loop radiating element comprises capacitive coupling means at a high differential voltage for the third harmonic for the half-loop radiating element; and
the capacitive coupling means is provided by a first part of the half-loop radiating element being interdigitated with a second part of the half-loop radiating element.

18. The antenna device of claim 17, wherein the inductive loading comprises a meandering portion.

19. The antenna device of claim 1, wherein the half-loop radiating element has a predetermined width for the first harmonic, and capacitive coupling means provided by a first part of the half-loop radiating element being widened towards a second part of the half-loop radiating element, compared to the predetermined width.

20. A portable radio communication device comprising the antenna device according to claim 1.
